(19) United States
(12) Patent Application Publication
(10) Pub. No.: US 2011/0202542 A1
(43) Pub. Date: Aug. 18, 2011

(54) INTEGRATION OF VOTER AND CONTRIBUTOR DATA INTO POLITICAL SOFTWARE AND COMPLIANCE SYSTEMS FOR PURPOSES OF SOLICITATION, COMPLIANCE, VETTING, AND CALLS TO ACTION

(75) Inventors: Dean Aris Phillips, Washington, DC (US); John Aris Phillips, New York, NY (US); James Xu, Damascus, MD (US); Brian Williams, Washington, DC (US); Peter Kelly, Washington, DC (US)

(73) Assignee: ARISTOTLE INTERNATIONAL INC., Washington, DC (US)

(21) Appl. No.: 13/026,886

(22) Filed: Feb. 14, 2011

Related U.S. Application Data
(60) Provisional application No. 61/303,775, filed on Feb. 12, 2010.

(51) Int. Cl. G06F 17/30

(52) U.S. Cl. 707/749; 707/770; 707/E17.071; 707/E17.014

(57) ABSTRACT

A system for gathering and analyzing data on individuals, comprising a processor connected to a network; a database server connected to the processor; a user database connected to the processor; and a user interface operable to interact with the processor and the user database; wherein the processor is operable to obtain information associated with a reference individual from sources connected to the network and store the information in the database server, wherein one source includes a social network database and the information includes related individual information; receive a search request from the user interface, search the information stored in the database server in response to the search request and generate a search result based thereon; determine a relevance value for the related individual information; cause the user interface to display the search result and relevance value; and store the search result in the user database as permitted by law.

### CROSS-REFERENCE TO RELATED APPLICATIONS

This disclosure claims priority from U.S. Provisional App. Ser. No. 61/303,775, entitled “Integration of Voter and Contributor Data into Political Software and Compliance Systems for Purposes of Solicitation, Compliance, Vetting, and Calls to Action,” filed Feb. 12, 2010, the entirety of which is incorporated by reference herein.

### BACKGROUND

Organizations such as political parties or non-profit entities may often rely on support from individuals. Such support can take the form of monetary contributions, donations of time and/or materials, and votes. Organizations may solicit donations from individuals at random or they may target certain potential donors based on known information about the potential donors. In the prior art, organizations evaluate a potential supporter based on information that has been supplied to the organization by the contributor or others with direct contact to the individual. Such information may be entered into a database and then used to predict the potential involvement of the individual. Such involvement may take the form of contributing money, volunteering, voting, and soliciting support for or against a candidate, issue or organization. Data utilized in the process is gathered from individuals and in bulk from lists that are provided to the organization by its supporters.

Some organizations may be required by law to submit data about donating individuals to federal, state, and/or municipal governments. For example, political organizations may supply information about their donors to government agencies to comply with campaign finance laws. Depending on the government organization, the required information may include: name; address; employer; occupation; phone numbers; email addresses; work address; employer business descriptions; relationship information regarding spouses, dependants, and other relatives; employer business relationships related to government contracting; political involvement including contribution history by related individuals or organizations; and/or other data. Some organizations, such as political organizations for example, may be restricted by law from accepting contributions from certain parties, such as foreign nationals or those who have given more than a maximum amount for a campaign, election cycle, or other government identified period. In the prior art, organizations verify compliance with these and other laws based on information that has been supplied to the organization by the contributor or others with direct contact to the individual. Some organizations also verify compliance by conducting their own manual research on a contributor.

### BRIEF DESCRIPTIONS OF THE DRAWINGS

FIG. 1 depicts a sample system block diagram according to an embodiment of the invention.

FIG. 2 depicts a sample contribution data extraction block diagram according to an embodiment of the invention.

FIG. 3 depicts a sample voting data extraction block diagram according to an embodiment of the invention.

FIG. 4 depicts a sample data retrieval flowchart according to an embodiment of the invention.

FIG. 5 depicts a sample relationship information screen according to an embodiment of the invention.

FIG. 6 depicts a sample voting information screen according to an embodiment of the invention.

FIG. 7 depicts a sample contribution information screen according to an embodiment of the invention.

FIG. 8 depicts a sample voter/contributor report screen according to an embodiment of the invention.

FIG. 9 depicts a node diagram according to an embodiment of the invention.

FIG. 10 depicts a sample contribution information screen based on the node diagram of FIG. 9 according to an embodiment of the invention.

FIG. 11 depicts a sample contribution information screen based on the node diagram of FIG. 9 according to another embodiment of the invention.

### DETAILED DESCRIPTION

While the following embodiments are discussed in the context of organizations receiving political contributions and/or other donations, it will be understood that this is for example only, and the scope of this disclosure is not limited to the fields of analyzing the backgrounds of potential donors or locating new potential donors. Data manipulation and interpretation can be used in a wide variety of devices, methods, and fields. Furthermore, while the following embodiments may be presented for use with specific systems, these are also presented as examples to provide greater understanding of the disclosure to those of ordinary skill in the relevant arts. For example, government structures and legislation of the United States are referenced, but embodiments of the invention may be adopted for use in other jurisdictions. Also, while some method steps are delineated as separate steps for ease of understanding, any such steps should not be construed as necessarily distinct nor order dependent in their performance.

Federal and state governments as well as other sources create official lists of voters, contributors, and contributions as submitted by various political organizations. These lists may be used to monitor compliance with campaign finance and operation laws. These lists may be maintained by the federal and state governments in a variety of forms and may be accessible in a variety of ways. For example, this data may be stored and maintained by federal election compliance authorities, state compliance authorities, third party vendors who provide services to government entities, state/county/city voter registration systems and their providers, and other entities. Governmental and non-governmental organizations may gather other data on individuals, organizations, and entities by geography, demography, marriage, membership, social network participation, political interests and associations, and/or other factors that may link the various data points together. This information may be used to monitor compliance with laws and to identify potential new donors to campaigns, where permitted by law.

Embodiments of the invention may provide systems and methods for locating, retrieving, analyzing, and extracting data from federal, state, and municipally gathered information on political contributions. Information may be culled from voter data, criminal background history, federal and state contributor and contribution records, and/or other sources. Information may also be gathered from social and commercial sources such as phone, financial transaction, real property, marriage, divorce, criminal citation, offender, and death listings; commercial listings of subscriptions, purchase habits, home renovations, and other data; social media; and/or other private or public information sources. In some cases the federal and state information may be resident on government established sites, servers, or data repositories and in some cases it may be resident on servers or in data repositories maintained by a third party data provider. The data may be base data and/or derived information from the analysis of the base data. The searched data may be stored in system databases and/or may be located elsewhere on a network such as the internet.

A user may request a search for information related to a known individual (the reference individual). The reference individual may be a person, organization, or any other legal entity. A user may enter known information about the reference individual into a computer. The computer may execute the search by matching various data points from the information that the user has already gathered to information recorded by various government authorities, non-governmental authorities, and/or their agents. When recorded information is retrieved, it may be displayed for the user. The search for related information may be based on name, address, geographic, and/or demographic characteristics of the reference individual as established by the user or based on other criteria as established by or for the user. At the user's request and depending on applicable state and federal regulations, the data may be incorporated into the user's database and systems. The user may use this data to evaluate the contribution and contributor for compliance with applicable laws related to campaign finance, for political vetting purposes, for purposes of solicitation and calls to action where allowed by law, and/or for other purposes.

On display of the retrieved data or at other times in the process, the user may be informed of various applicable state and federal restrictions on use of the information retrieved. Incorporation of any retrieved data may be at the option of the user. Applicable legal restrictions on particular data points to be added may be applied when a user attempts to access or use those data points.

In some embodiments of the invention, related information is not restricted to information pertaining directly to the reference individual. It may include information on individuals associated with or related to the reference individual by geography, demography, marriage, membership, social network participation (for example, Facebook and LinkedIn activity and relationships), political interests and associations, and/or other factors that may link the individuals together. Information about associated individuals may be used to evaluate the reference individual (such individuals will be referred to herein as related individuals). Also, each related individual may be a potential new reference individual, in accordance with applicable legal restrictions.

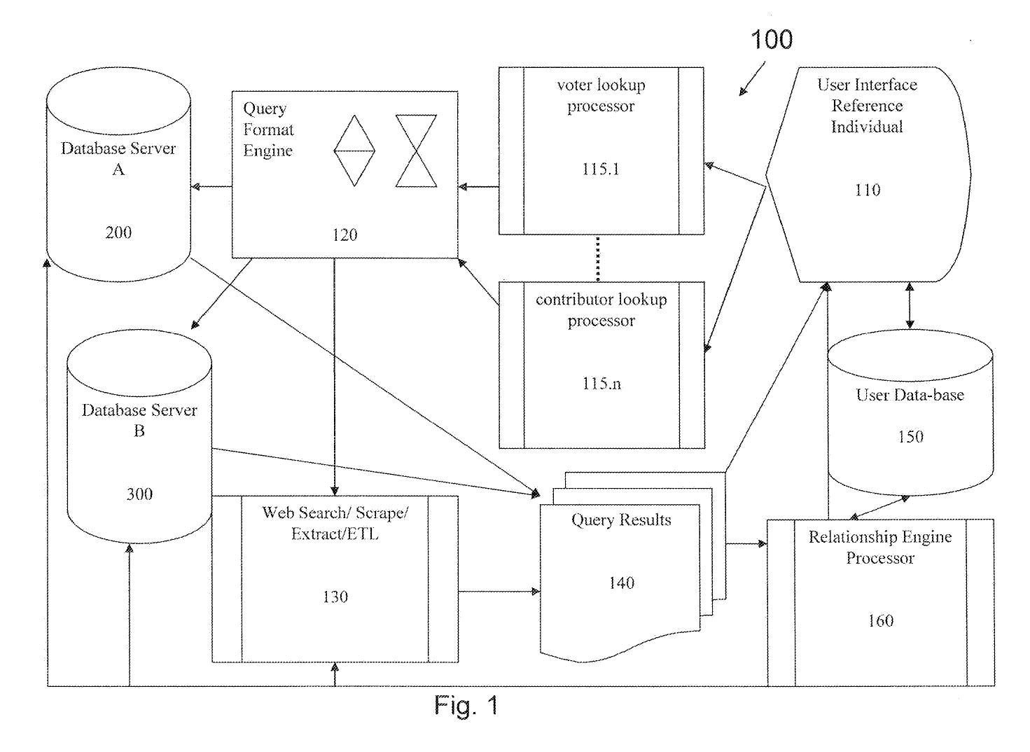

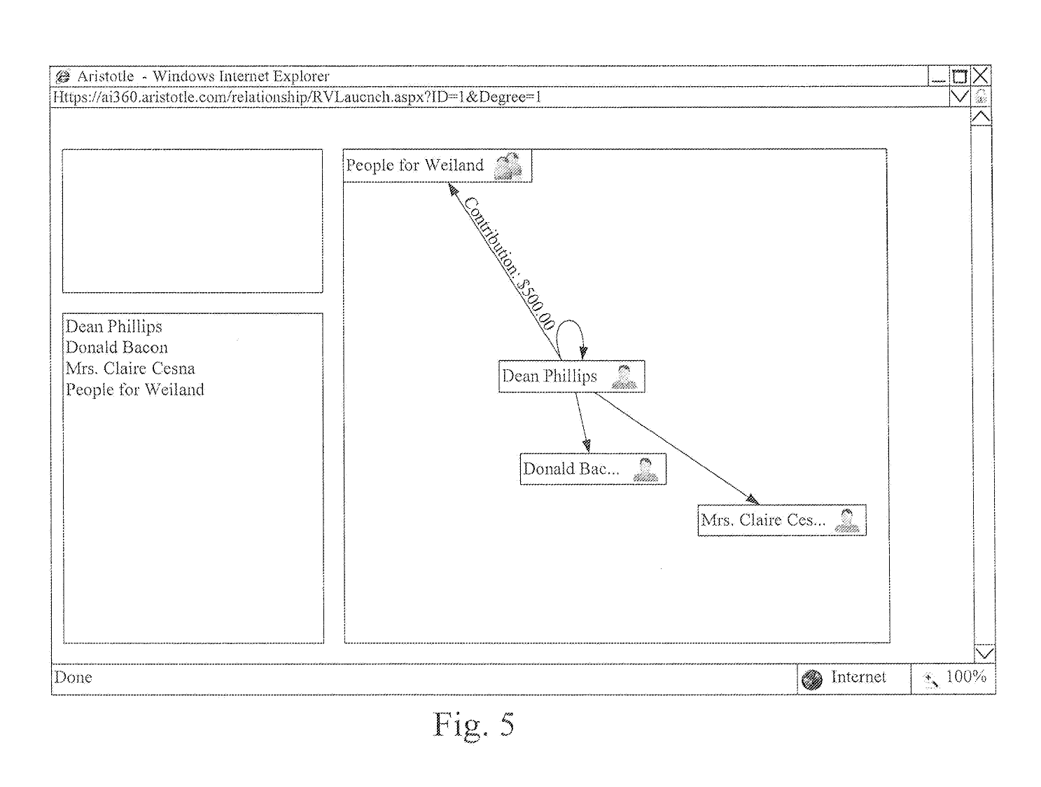

FIG. 1 depicts a sample system block diagram according to an embodiment of the invention. The system 100 may include at least one processor and a user interface 110 which may be accessible by a user through a network connection with the processor or directly accessible. The user interface 110 may include multiple technologies such as web browsers, PDF generators and viewers, report generators, and/or other interfaces for the user. The system 100 may receive user inquiries for individual data made through the interface 110. The system may be directed to perform voter data lookup, contributor data lookup, or other reference data lookup using one or more of the lookup processors 115.1-115.n. The lookup processors 115 may be individual physical processors or logic handled by one or more physical processors. The user may activate the voter, contributor or other reference data lookup feature through a control 200.1 to 200.n. The lookup processors 115 may examine data provided through the user interface 110 and/or data residing in the user database 150 and may pass the data to the query format engine 120. The query format engine 120 may execute queries against various databases (such as database server A 200 and database server B 300) and the interactive web scraping and querying engines 130. While two database servers 200 and 300 and one Web search/Scrape/Extract/ETL server 130 are shown in FIG. 1, other combinations and numbers of servers are possible. The database queries and engines 130 may return results 140 that may be processed by the user interface 110 as well as by the relationship engine 160. The user interface 110 may display the retrieved information to a user. The user interface 110 may also give the user the option to save or update information on the reference individual in the user database 150 or to simply view it and discard it. The relationship engine 160 may analyze the returned information and may execute additional queries against the databases 200 and 300 and the web search engine 130 to provide additional search results for the user in accordance with applicable legal restrictions. The output of the user interface 110 may include displays illustrating relationships, briefings, and/or other displays which are discussed below and shown in FIGS. 5-8. The formats of the outputs may adjust according to the particular data that is produced by a search.

In some embodiments, the relationship engine may process data in the following manner. If the initial search of voter data (or contributor data or other data) provides information on related individuals, then the relationship engine 160 may use that information to search for relevant information on those related individuals. The relationship may be by any number of links such as geography, affiliation, employment, demographics and history, and/or support both financial and otherwise of a cause, campaign, or other organization. The related individual information may provide more data about the reference individual. One reference individual may lead to many other related individuals, each of whom may in turn lead to other individuals. In some embodiments, the degree of separation between the reference individual and the related individuals may be specified by the system and/or the user.

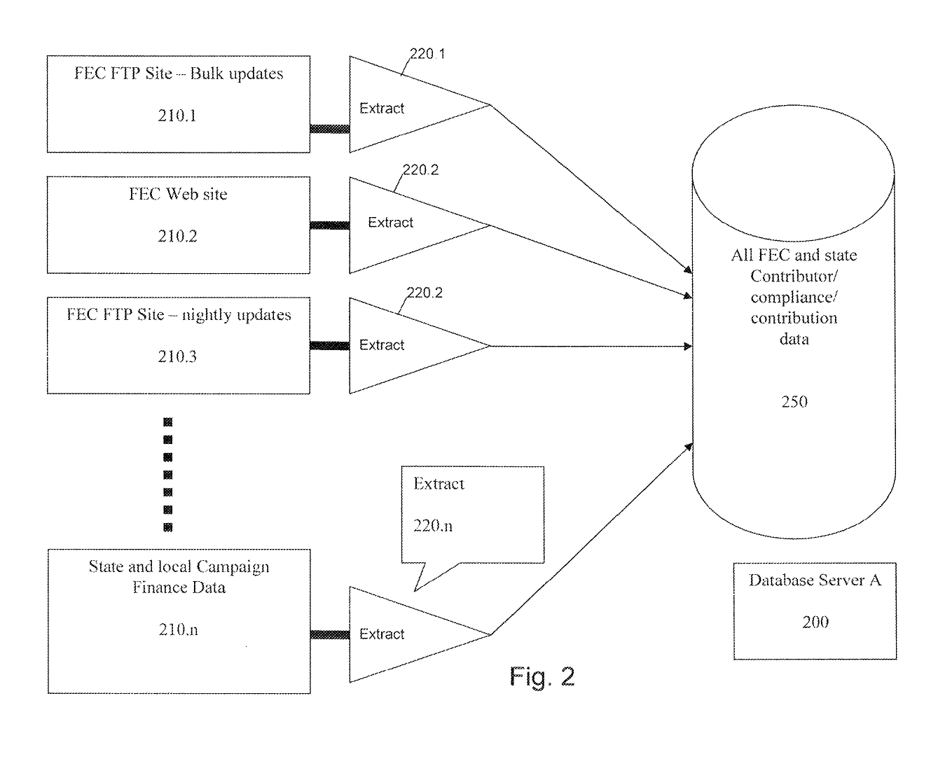

FIG. 2 depicts a sample contribution data extraction block diagram according to an embodiment of the invention. A reference individual record may include that individual's name and address. The record may also include additional contact or related information that may have been added based on a user's interactions with the reference individual or data purchased or provided to the user and subsequently inputted into the system. FIG. 2 illustrates an embodiment of the invention wherein external information may be integrated into the system. This data may be from any of the sources discussed above, such as government election compliance records or privately maintained records of election information. Embodiments of the invention may use other types of information. The system may receive data from various sources 210.1-210.n. In some cases, contents of external databases such as government record databases or social network databases may be obtained in their entirety or in part by the system. In other cases, the system may search such databases for subsets of information contained within. The system (i.e., the interactive web scraping and querying engine 130) may extract information 220.1-220.n on one or more reference individuals from each inputted source 210.1-210.n. This data may be processed such that information 220.1-220.n on any particular reference individual is consolidated into a single record 250 or several linked records. Records 250 may be stored on a database server 200 and made searchable by a user. The database server 200 may provide a common location for all information of a certain type (for example, campaign contribution data), one server 200 may store multiple types of data, or data of a certain type may be stored in multiple servers 200.

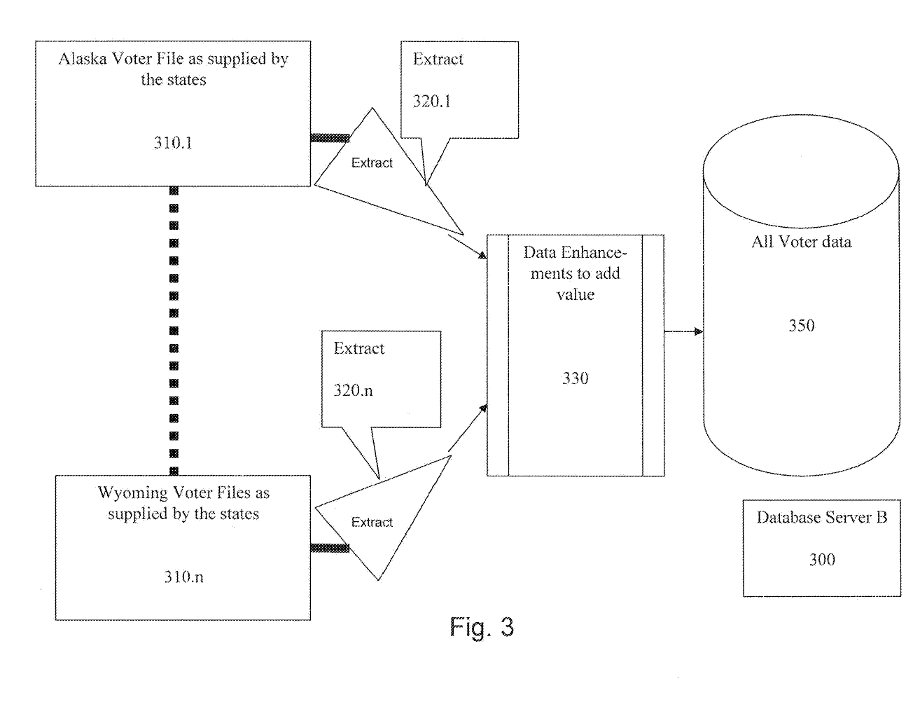

FIG. 3 depicts a sample voting data extraction block diagram according to an embodiment of the invention. This data extraction example is similar to that of FIG. 2, but includes data enhancement 330 features. This data may be from any of the sources discussed above, such as voter data from federal, state, county, municipal, or other entities. Embodiments of the invention may use other types of information. The system may receive data from various sources 310.1-310.n. In some cases, contents of external databases such as government record databases or social network databases may be obtained in their entirety or in part by the system. In other cases, the system may search such databases for subsets of information contained within. The system may extract information 320.1-320.n on one or more reference individuals from each inputted source 310.1-310.n. In some embodiments, data collected from the sources 310.1-310.n may be enhanced 330 with other data, or the data from the sources 310.1-310.n may be used to enhance existing data. This data may be processed such that information on any particular reference individual is consolidated into a single record 350 or several linked records. Records 350 may be stored on a database server 300 and made searchable by a user. The database server 300 may provide a common location for all information of a certain type (for example, campaign contribution data), one server 300 may store multiple types of data, or data of a certain type may be stored in multiple servers 300.

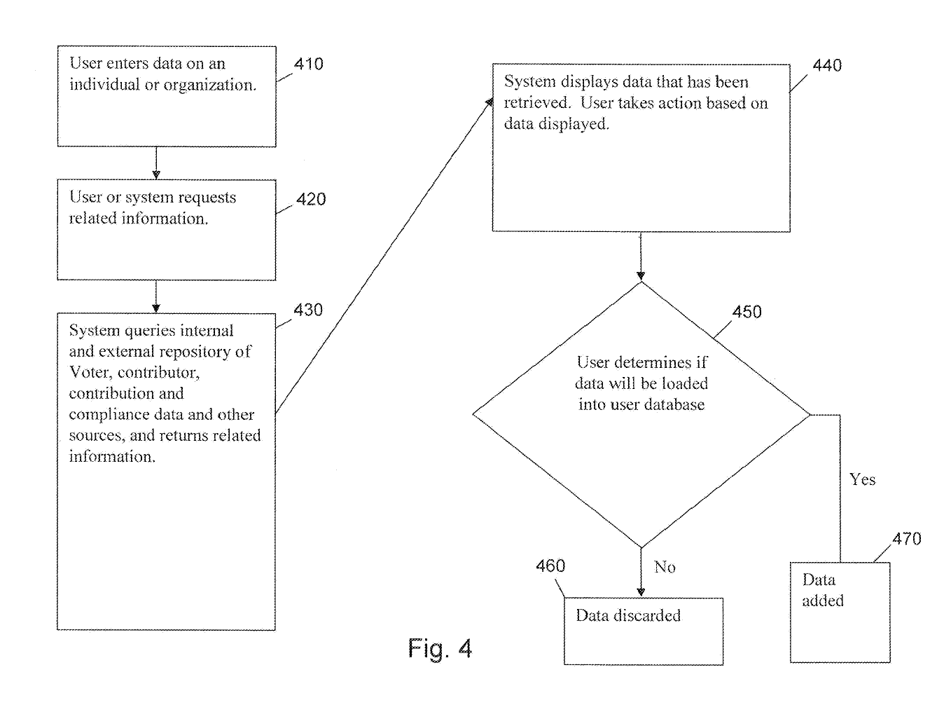

As discussed above, data that has been extracted may be made searchable and retrievable by a user. FIG. 4 depicts a sample data retrieval flowchart according to an embodiment of the invention. In this example embodiment, information about a reference individual may be used to search for information about related individuals. A user may supply the system with information on a reference individual 410, or the reference individual 410 may be selected from a list of reference individuals already in the user's organization's database. The system may automatically and/or in response to user command formulate initial queries for related information 420. The system may search 430 for information in the databases that matches data points for the reference individual in order to find related individuals. Related individuals or organizations may share some common data points or nodes. These nodes may have relative values indicative of their importance depending on the type of data they represent and the specific information within the node. Logic routines (for example the relationship engine processor 160 of FIG. 1) may be employed to determine a relevance value indicative of the relative importance of links between individuals. Logic rules may use the relative values for each of the nodes to create the relevance values for links. Relative importance may be determined by evaluating the combination of attributes of the related individual and comparing them to those of the reference individual. If, for example, a related individual lives in the same neighborhood and is employed by the same company as the reference individual and both individuals have children, the relationship may be more relevant (and therefore the relevance value may be higher) than if the individuals are merely employed by the same organization with no other connections. In another example, a link indicating that individuals share the same giving history to political or charitable organizations may be more significant than a link that is based solely on geography.

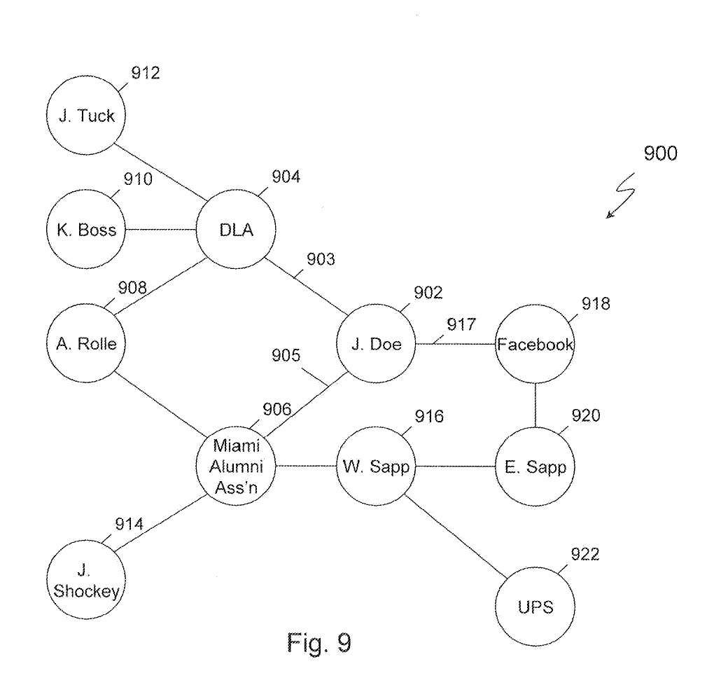

FIG. 9 illustrates an example of a node diagram for a related individual, John Doe, shown in node 902, which may be formed in order to generate a report in connection with a search conducted by user for an organization. J. Doe has been identified as a related individual due to certain relationships, described further below, he shares with an individual, A. Rolle. As discussed above, A. Rolle's name may be supplied by the user conducting the search, or may selected by the user from a list of names of members of the organization for whom the user is conducting the search, or he may be a person who previously supported the organization, or his name may be known to the user/organization for some other reason. Because J. Doe works for an employer known as DLA in this example, he is linked to the DLA node 904, and because J. Doe is a member of the University of Miami Alumni Association, he is also linked to the Miami Alumni Ass'n node 906 (information identifying employees of organizations such as law firms and alumni associations may be obtained from a wide variety of sources, and is often available on the websites of such organizations). Finally, J. Doe is linked to the Facebook node 918 through his account on Facebook.

In some embodiments, a relevance value will be calculated for each of these three primary links 903, 905, 917 to the nodes 904, 906, 918. The relevance value calculated for these three links to J. Doe depends on values associated with the nodes 904, 906, 918 associated with these three links. The value of each node 904, 906, 918 depends on the characteristics of the other people linked to the node, the number of other people associated with the node, and, in some cases, on a characteristic associated with the node itself.

In this fictitious example, a search is being run by a political organization to identify potential supporters, and DLA is a fictitious law firm that sponsors a fictitious political action committee, or PAC. Information about the activities of the PAC may be available through public databases, and this information may provide a basis for assigning, either manually or automatically, a value to the DLA node. In some embodiments, a node for which no information is available or for which the available information does not provide a basis upon which to assign a value, a default value or no value is assigned to the node. It should also be understood that the value assigned to a node may change depending on the nature of the search. For example, a node may be assigned a large positive value for the purposes of a search for supporters for one party, a large negative value for a search for supporters for the other party, and little or no value for the purposes of a search for supporters of a charitable cause such as PETA.

The value assigned to the DLA node for the purposes of the exemplary search also depends on the values assigned to individuals directly linked to the node, which in this case is the nodes A. Rolle, 908, K. Boss 910 and J. Tuck 912. Information for these individuals may be obtained from the organization's own database (in this case, information on A. Rolle is in the organization's database) or from public sources such as state and FEC databases and motor vehicle registration databases. Values assigned to these individuals for the purposes of the search may depend on factors such as political party affiliation, past monetary contributions, etc.

The actual values assigned to the nodes depend upon the particular implementation. In one embodiment, each node will have a value between −1 and +1, with the particular values assigned depending on the application. For example, in a search designed to identify potential monetary supporters for a political party, nodes associated with individuals may be assigned a number between 0 and +1 depending on the amount of their contributions over the last three years to political organizations of all types, and organizations may be assigned a default value of 0 if their political affiliation is known or a value of 1 if there is a perceived similarity in political views. In some embodiments, negative values may be assigned for past donations to organizations (people) or political views (organizations) deemed to be opposed to those of the organization conducting the search.

In the example of FIG. 9, the search will be limited to people with no more than one degree of separation to J. Doe; meaning people who are directly connected to organizations to which A. Rolle is directly connected. Thus, in FIG. 9, the E. Sapp node 920 (which is directly connected to the W. Sapp node 916 through marriage) is not considered when calculating the value for node 906 because the E. Sapp node 920 is not directly connected to node 906, but the E. Sapp node 920 is counted when calculating the value for node 918 because the E. Sapp node 920 is directly connected to node 918. Likewise, the UPS node 922 (i.e., the employer of E. Sapp) does not contribute to the value for any of the nodes 904, 906, 918 and thus does not contribute in any way to the relevance value calculated for the J. Doe node 902. In other embodiments in which more than one degree of separation is considered, the relevance value calculated for the J. Doe node 902 would depend upon the UPS node 922.

The values for nodes 906 and 918 are calculated in a manner similar to that discussed above. It should be noted that whether a person is directly connected to another person through a node may vary depending on the type of node. For example, in some embodiments, any employee of DLA is considered to be directly connected to all other employees of DLA. In other embodiments, only certain employees of DLA (e.g., those in the same geographical office location) may be considered to be directly connected. Similarly, with respect to Facebook node 918, only friends (rather than all members of Facebook) may be considered to be directly connected. It should also be noted that certain nodes may be counted multiple times due to the existence of multiple links. For example, as shown in FIG. 9, the A. Rolle node 908 is connected to the J. Doe node 902 via both the DLA and Miami Alumni Ass'n nodes 904 and 906, whereas others such as the J. Shockey node 914 are only connected to the J. Doe node 902 via one node. Thus, the value of the A. Rolle node 908 will have more influence on the relevance value for the J. Doe 902 node than on the J. Shockey node 914.

In the foregoing example, there are no direct connections between any of the organizations (DLA, UPS, Facebook) shown. In other embodiments, direct connections between organizations may exist. For example, direct connections between local chapters and national associations of fraternities and/or labor unions may be formed. When direct connections between organizations are allowed, such direct connections may or may not be counted as a degree of separation. In other words, in a situation in which a first person connected to a local chapter of a sorority which in turn is connected to a national fraternal organization which in turn is connected to a second person, the first person may be considered to be separated by one or two degrees of separation, depending on the implementation chosen for the embodiment.

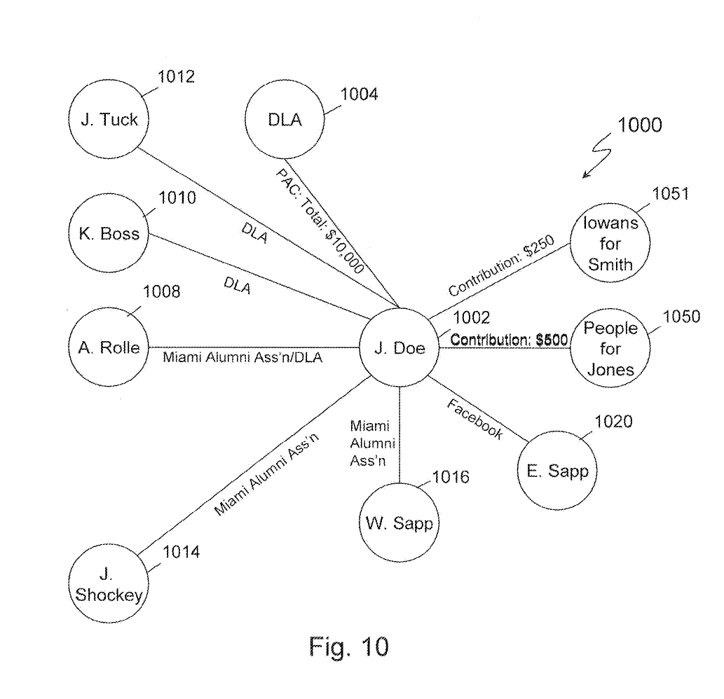

As discussed above, the node diagram 900 of FIG. 9 may be used to display a report to the user during a search. An exemplary report 1000 that may be displayed to a user is illustrated in FIG. 10. The report 1000 of FIG. 10 shows those related individuals to whom the reference individual J. Doe node 1002 is directly connected. The connection is shown as a direct line, with the reason for the connection shown below the line. For example, the J. Doe node 1002 is directly connected to the J. Tuck node 1012 through DLA, and is directly connected to the A. Rolle node 1008 through both DLA and the Miami Alumni Ass'n nodes. In some embodiments, the links may be color coded to reflect the type of link (e.g., links to employers may be shown in green, links to social organizations may be shown in blue, etc.). In other embodiments, the links may be color coded depending on the reference values associated with the nodes through which the links run. For example, the links to the J. Tuck node 1012 and the K. Boss node 1010 in FIG. 10 may be shown in a color that depends upon the reference value calculated for the DLA link 903 (as shown in FIG. 9); the link to the J. Shockey node 1014 in FIG. 10 may be shown in a color that depends upon the reference value calculated for the Miami Alumni Ass'n link 906, and the link to the A. Rolle node 1008 in FIG. 10 may be based on some function (e.g., greatest of, average, etc.) of the reference values for the links 903 and 906.

Also shown in FIG. 10 are campaigns 1050, 1051 to which the reference individual J. Doe node 1002 has contributed. Beneath each of these links, the amount of the actual contributions is also shown. FIG. 10 also includes a display of a DLA node 1004. The DLA node 1004 is included because the DLA organization has an associated PAC which makes contributions. Organizations without separate activities, such as the Miami Alumni Ass'n, are not shown in FIG. 10.

As discussed above, this contribution information could be used for compliance reporting purposes. As discussed above, for compliance purposes, there is no current legal restriction on the use of data from any sources, so the contribution information can come from any source, including U.S. Federal Election Commission databases and all state and local databases. In the event that a search were being run in order to identify potential contributors, some embodiments of the invention do not display contribution data from any database from which the use of such contributor data is not legal. In other embodiments in which the purpose of the search is not known, the information and its source may be displayed so that the person performing the search may disregard any data from a source for which use of the data for the purpose of the search is not legal. In yet other embodiments, an option to disable the display of data from particular sources is provided to the user.

A user may take action based on the data displayed. For example, the system may aid in the determination of appropriateness of association with a potential supporter. By viewing organizations or individuals to whom the reference individual is related, a political organization may determine that being associated with that individual is or is not desirable.

In another example, the system may identify individuals who may have made maximum or excessive contributions based on federal, state, and/or municipal limits during a specified period of time. Regulations may limit the annual amount that an individual or organization may give to any candidate, Political Action Committee (PAC), party, or other political entity. The system may allow a user to view the reported contributions to other political organizations and thus the user may avoid accepting improper or illegal contributions.

In another example, the system may facilitate compliance with legislation requiring lobbying organizations to know and report on contributions by lobbyists and their spouses to federal campaigns and organizations that are under the jurisdiction of the Federal Election Commission (FEC) or similar laws. Organizations receiving contributions and organizations by which a lobbyist is employed may be required to disclose information. If information regarding a contributor or lobbyist is incomplete, a user may wish to obtain additional data to comply with these disclosure requirements or for other reasons. By viewing the related activities of an individual and/or other information not directly disclosed to the organization, a user may be able to gather missing information.

In another example, the system may allow a user to find supporters. Supporters may be identified by their relationship to a reference individual who may be a supporter or potential supporter. The roadmap provided by the invention may provide a user with information enabling the user as permitted by law to seek support of those who may likely be positively disposed to contributing to the user's organization. This may be done in some embodiments by displaying contribution data for reference individuals as shown in FIG. 10, or alternatively displaying this data when a user clicks on a node of a related individual. The user may be guided as to which nodes to consider by the relevance values associated with the links of each of the nodes. In some embodiments, nodes with relevance values below a threshold may not be displayed at all, such that the user is only shown the links with the highest relevance values.

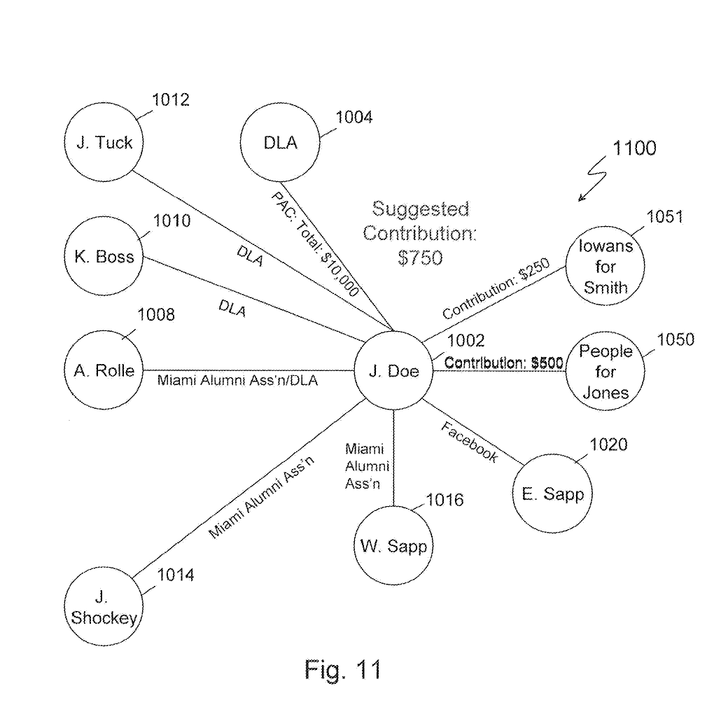

In some embodiments, guidance as to how much to ask for from a reference individual may be calculated and displayed to the user as shown in FIG. 11. The guidance may be based, for example, on a combination of the relevance values for each of the links and contributor data (which may be limited to contributions of the same type to which the search is directed, such as political contributions, or may include contributions of other types such as charitable contributions) of the related individuals connected to reference individual. The contributor data may be culled from one or more of a variety of sources, such as state databases and the organization's own databases, and may exclude any data source whose use is not legal for such purposes.

Referring now back to FIG. 4, the system may allow retrieved data to be included in the system database. A user may examine the displayed data and decide whether to add it to the database and/or modify existing information 450. Based on this decision, the data may either be discarded 460 or stored 470.

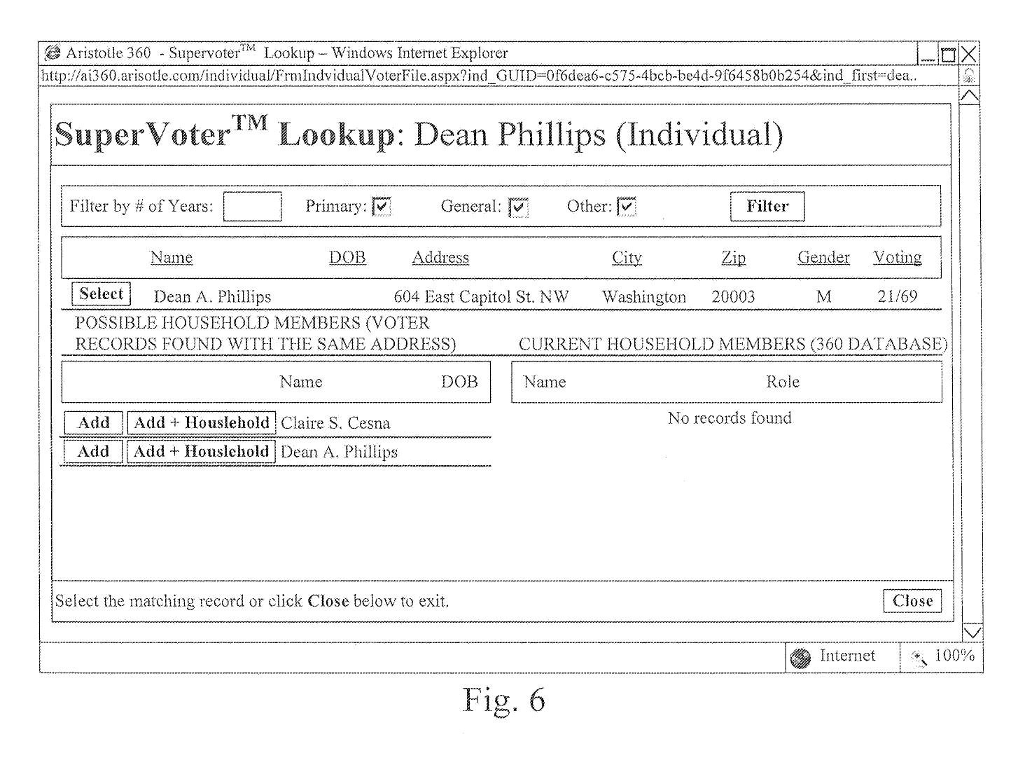

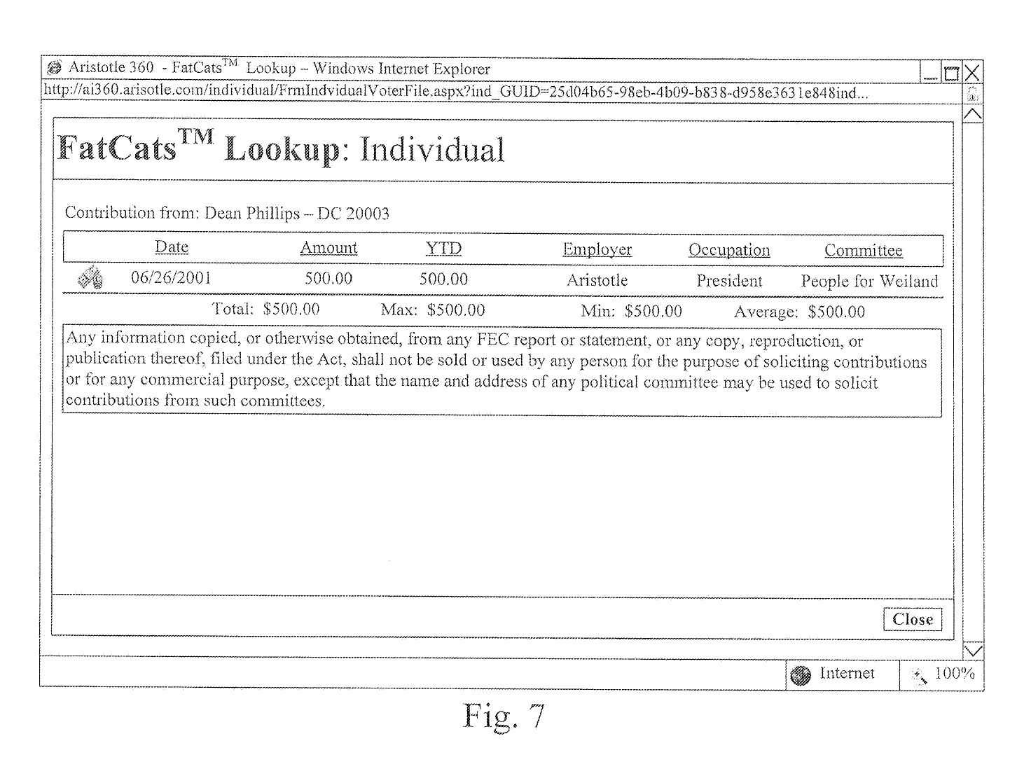

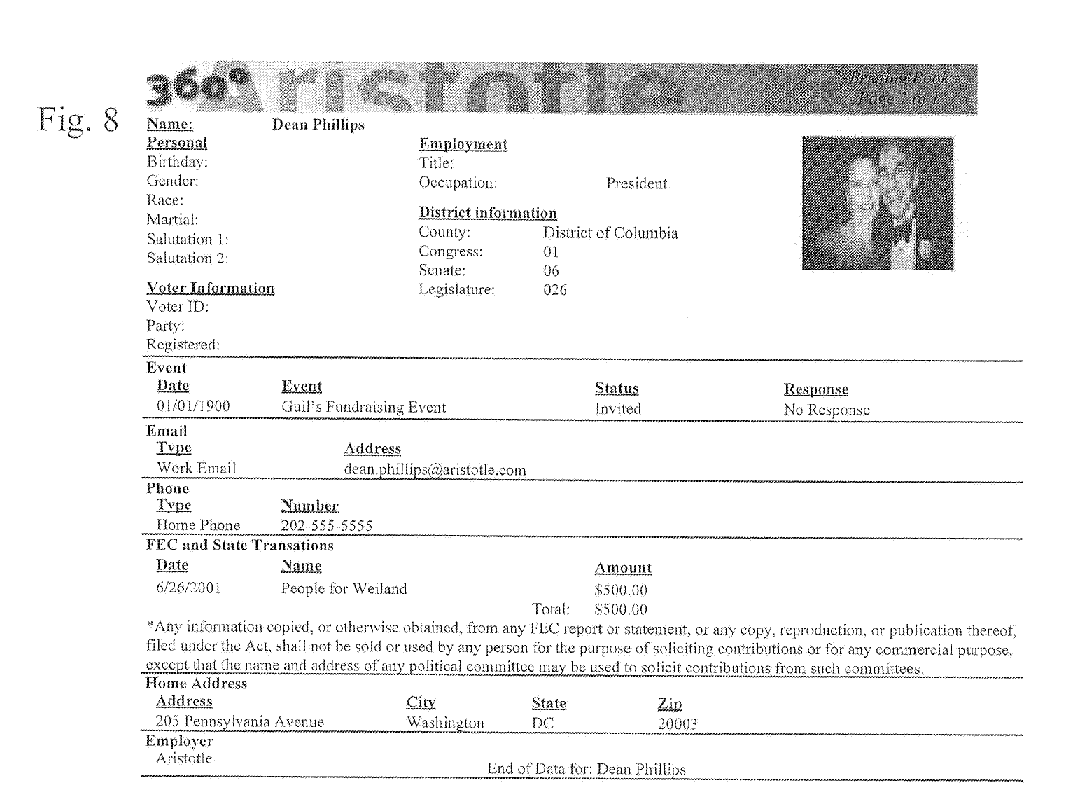

The system may display data 440 to a user in the form of reports and/or displays which may arrange and sort the data in a variety of ways. FIGS. 5-8 and 10-11 depict screenshots of example reports. These figures are presented as examples only, and embodiments of the invention may include additional or fewer reports and may present reports in different forms. FIGS. 5-6 depict reports illustrating how related individuals may be related to searched reference individuals. FIG. 7 depicts a report illustrating political contributions made by a reference individual. FIG. 8 depicts a briefing report including all information about an individual gathered by a search, including federal, state, and municipal contribution histories and voter information.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages, are presented for example purposes only. The disclosed methodology and system are each sufficiently flexible and configurable, such that it may be utilized in ways other than that shown.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. §112, paragraph 6. Claims that do not expressly include the phrase “means for” or “step for” are not to be interpreted under 35 U.S.C. §112, paragraph 6.

1. A system for gathering and analyzing data on individuals, comprising:
a processor operable to be connected to a network;
a database server connected to the processor;
a user database connected to the processor; and
a user interface operable to interact with the processor and the user database;
wherein the processor is operable to
obtain information associated with at least one reference individual from at least one source connected to the network and store the information in the database server, wherein at least one of the sources includes a social network database and the information includes related individual information;
receive a search request from the user interface, search the information stored in the database server in response to the search request and generate a search result based on the information stored in the database server;
cause the user interface to display the search result; and
store the search result in the user database.

2. The system of claim 1, wherein the processor is operable to search at least one external data source connected to the network in response to the search request and generate the search result based on information stored in the external data source and the information stored in the database server.

3. The system of claim 1, wherein the processor is operable to enhance the information associated with the at least one reference individual.

4. The system of claim 1, wherein the information associated with the at least one reference individual includes voter registration information.

5. The system of claim 1, wherein the information associated with the at least one reference individual includes support data.

6. The system of claim 5, wherein the support data includes contribution data.

7. The system of claim 6, wherein the processor is operable to calculate a suggested contribution for the reference individual based on the contribution data and at least one relevance value.

8. The system of claim 6, wherein the contributor data is obtained from at least one source selected from the group consisting of, state contributor data, local contributor data, and contributor data from the user database.

9. The system of claim 1, wherein the processor is operable to cause the user interface to display legal restrictions.

10. The system of claim 1, wherein:
the processor is operable to analyze the search result to determine whether causing the user interface to display the search result is legal; and
the processor is operable to cause the user interface to display the search result only when causing the user interface to display the search result is legal.

11. The system of claim 1, wherein:
the processor is operable to analyze the search result to determine whether storing the search result in the user database is legal; and
wherein the processor is operable to store the search result in the user database only when storing the search result in the user database is legal.

12. The system of claim 1, wherein:
the processor is operable to search the information stored in the database server in response to the related individual information and generate a related individual search result based on the information stored in the database server;
wherein the processor is operable to cause the user interface to display the related individual search result; and
wherein the processor is operable to store the related individual search result in the user database.

13. The system of claim 1, wherein:
the processor is operable to receive a related individual definition from the user interface; and
wherein the processor is operable to determine whether a piece of information is related individual information based on the related individual definition.

14. A method of gathering and analyzing data on individuals, comprising:
obtaining information associated with at least one reference individual from at least one source, wherein at least one of the sources includes a social network database and the information includes related individual information;
storing the information associated with the at least one reference individual;
receiving a search request;
searching the stored information in response to the search request;
generating a search result based on the stored information; and
displaying the search result and the relevance value.

15. The method of claim 14, further comprising storing the search result.

16. The method of claim 14, further comprising:
searching at least one external data source in response to the search request;
generating the search result based on information from the external data source and the stored information.

17. The method of claim 14, further comprising enhancing the information associated with the at least one reference individual.

18. The method of claim 14, wherein the information associated with the at least one reference individual includes voter registration information.

19. The method of claim 18, further comprising determining whether using the voter registration information to evaluate a donation from the reference individual would be subject to a legal restriction.

20. The method of claim 19, further comprising determining whether a donation from the reference individual would be subject to a legal restriction based on the voter registration information.

21. The method of claim 14, wherein the information associated with the at least one reference individual includes political contribution information.

22. The method of claim 21, further comprising determining whether a donation from the reference individual would be subject to a legal restriction based on the political contribution information.

23. The method of claim 14, further comprising displaying legal information.

24. The method of claim 14, further comprising:
analyzing the search result to determine whether displaying the search result is legal; and
displaying the search result only when displaying the search result is legal.

25. The method of claim 15, further comprising:
analyzing the search result to determine whether storing the search result is legal; and
storing the search result only when storing the search result is legal.

26. The method of claim 14, further comprising:
searching the stored information in response to the related individual information;
generating a related individual search result based on the stored information; and
displaying the related individual search result.

27. The method of claim 26, further comprising storing the related individual search result.

28. The method of claim 14, further comprising:
receiving a related individual definition; and
determining whether a piece of information is related individual information based on the related individual definition.

29. The method of claim 14, further comprising determining a relevance value for the related individual information and determining a desirability of a donation from the reference individual based on the related individual information and the relevance value.

30. A method for verifying compliance with fundraising laws, comprising:
obtaining information associated with at least one reference individual from at least one source, wherein the information includes voter registration information;
storing the information associated with the at least one reference individual;
searching the stored information;
generating a search result based on the stored information;
displaying the search result; and
determining whether a donation from the reference individual would be subject to a legal restriction.
